(19) United States
(12) Patent Application Publication
(10) Pub. No.: US 2025/0124373 A1
(43) Pub. Date: Apr. 17, 2025

(54) WIRELESS INTELLIGENT SITE EVALUATION

(71) Applicant: Dysruptek LLC, Jacksonville, FL (US)

(72) Inventor: Hamzah A. Shanbari, Jacksonville, FL (US)

(21) Appl. No.: 18/888,818

(22) Filed: Sep. 18, 2024

Related U.S. Application Data
(60) Provisional application No. 63/589,464, filed on Oct. 11, 2023.

(51) Int. Cl. G06Q 10/0631; G06Q 50/08

(52) U.S. Cl. CPC G06Q 10/063114; G06Q 50/08

(57) ABSTRACT

A system for monitoring construction progress at a jobsite may comprise one or more nodes positioned at the jobsite. The system may include at least one hardware processor. One or more computer-readable storage media may store instructions which, when executed by the at least one hardware processor, may cause the system to perform operations. The operations may comprise emitting a Wi-Fi signal from at least one of the one or more nodes. The operations may include receiving the emitted Wi-Fi signal by at least one of the one or more nodes. One or more measurements may be performed based at least in part on the received Wi-Fi signal. The one or more measurements may be provided as input to a trained machine learning model. An indication of construction progress at the jobsite may be generated as output from the trained machine learning model.

### RELATED APPLICATION

Under provisions of 35 U.S.C. § 119 (e), the Applicant claims benefit of U.S. Provisional Application No. 63/589,464 filed on Oct. 11, 2023, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to computer vision techniques, and more specifically to the use of Wi-Fi signals for evaluating construction progress at a jobsite.

### BACKGROUND

In some situations, it may be necessary to evaluate construction progress at an interior site (e.g., a jobsite) remotely. Cameras can be positioned at a jobsite, but may interfere with workers' construction. Additionally, cameras have limited field of view and require particular lighting conditions to accurately display current conditions. Still further, cameras have limitations regarding what can be shown. For example, if a wall is erected, in front of a camera, the camera is no longer useful for seeing construction progress on the opposite side of the wall.

Accordingly, there is a need for a remote site evaluation platform that uses technology other that visual spectrum radiation to collect and convey data regarding construction at the site.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Wi-Fi-based object detection is a technique that leverages the characteristics of Wi-Fi signals, particularly their ability to penetrate walls and objects, to detect the presence, shape, and/or movement of objects in an environment. This approach has gained attention due to its potential to operate without relying on traditional vision-based sensors (cameras), making it particularly suitable for applications where privacy is a concern or where visual sensing is limited by, for example, poor lighting conditions.

The present platform expands upon existing works in computer vision and object detection by using Wi-Fi transceivers (e.g., wireless routers) to track and interpret interference generated by their surroundings. The Wi-Fi transceivers are less expensive than traditional computer vision systems, which may rely on LiDAR or video capture. The platform may provide received Wi-Fi interference data to a deep-learning model that may be used, either alone or in combination with an anticipated construction schedule, to determine when particular projects are completed.

In some embodiments, the deep learning model may be trained using both the Wi-Fi interference data and camera pixel data to determine construction project completion and corresponding changes to the Wi-Fi interference data. The interference data and weighted image-byproduct data are synchronized and used to establish a training dataset based on the presence or lack of construction material in the image frame and Wi-Fi signal path.

By investing in connectivity infrastructure within a building, rather than expensive robotics or photogrammetry tools, construction professionals can obtain better site operations beyond progress tracking alone. The robust network architecture improves data transfer to and/or from the job site, and enables use of more and/or better construction technologies. Another unspoken positive byproduct of using Wi-Fi interference data for computer vision is that lighting quality and gaseous interference (like smoke) have far less influence on the created scene.

A system for monitoring construction progress at a jobsite may comprise one or more nodes positioned at the jobsite. The system may include at least one hardware processor. The system may include one or more computer-readable storage media storing instructions. The instructions, when executed by the at least one hardware processor, may cause the system to perform operations. The operations may comprise emitting a Wi-Fi signal from at least one of the one or more nodes. The operations may comprise receiving the emitted Wi-Fi signal by at least one of the one or more nodes. The operations may comprise performing one or more measurements based at least in part on the received Wi-Fi signal. The operations may comprise providing the one or more measurements as input to a trained machine learning model. The operations may comprise generating, as output from the trained machine learning model, an indication of construction progress at the jobsite.

A method for monitoring construction progress at a jobsite may comprise positioning one or more Wi-Fi nodes at a construction site. The method may comprise emitting Wi-Fi signals from at least one of the one or more Wi-Fi nodes. The method may comprise receiving, by at least one of the one or more Wi-Fi nodes, the emitted Wi-Fi signals. The method may comprise extracting channel state information (CSI) data from the received Wi-Fi signals. The method may comprise processing the extracted CSI data to generate processed CSI data. The method may comprise inputting the processed CSI data into a trained machine learning model. The method may comprise generating, by the trained machine learning model, an output indicating construction progress at the construction site. The method may be performed by at least one computing device comprising a hardware processor.

One or more non-transitory computer readable media may comprise instructions which, when executed by one or more hardware processors, may cause performance of operations. The operations may comprise receiving, at a computing device, Channel State Information (CSI) data collected from one or more Wi-Fi nodes positioned at a construction site. The operations may comprise processing the CSI data to extract features indicative of physical objects present at the construction site. The operations may comprise providing the extracted features as input to a trained machine learning model. The operations may comprise generating, using the trained machine learning model, a representation of the construction site based on the extracted features. The operations may comprise comparing the generated representation to a predetermined construction plan for the construction site. The operations may comprise determining, based on the comparison, a measure of construction progress at the construction site. The operations may comprise outputting an indication of the determined measure of construction progress.

The following disclosure may describe systems, methods, and computer-readable media for monitoring construction progress at a jobsite. Various embodiments may be described, but these are provided for illustrative purposes only and are not intended to be limiting. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a wireless intelligent site evaluation platform;

FIG. 3A shows an example layout of a jobsite containing three nodes before construction has begun;

FIG. 3B shows an example layout of the jobsite containing three nodes after construction has begun;

FIG. 4 is a block diagram of a system including a computing device for performing the method of FIG. 2; and

FIG. 5 illustrates a chart showing the ability of the machine learning model to correctly discern objects based on the received data.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of an intelligent site evaluation platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Wi-Fi is a wireless networking technology that enables devices (e.g., computers, smartphones, and other capable devices) to exchange data with each other and access the Internet without the need for a physical, wired connection. Wi-Fi operates within the electromagnetic spectrum, utilizing radio frequencies to transmit and receive data through the air. The functioning of Wi-Fi involves the transmission of data, access points and routers, modulation techniques, SSID and channels, security measures, and the process of connecting devices. The evolution of Wi-Fi standards set forth by the Institute of Electrical and Electronics Engineers (IEEE), including (but not limited to) 802.11n (Wi-Fi 4), 802.11ac (Wi-Fi 5), and 802.11ax (Wi-Fi 6), has led to improvements in speed, frequency use, and range.

Channel state information (CSI) provides physical channel measurements in subcarrier-level granularity, and can be easily accessed from a commodity Wi-Fi network interface controller (NIC). CSI data describes the propagation process of the Wi-Fi signal. The CSI data contains geometric information of the propagation space. Thus, understanding the mapping relationship between CSI and spatial geometric parameters lays the foundation for designing a feature extraction and sensing algorithm. CSI data plays a role in Wi-Fi-based object detection. CSI data may encompass concepts such as, but not limited to, wireless communication channels, multipath propagation, and frequency selectivity. The CSI data includes amplitude and phase information, and can be classified as instantaneous or statistical CSI. The measurement and representation of CSI data involves obtaining the data and representing it in specific formats. CSI finds applications in techniques like beamforming, MIMO (Multiple Input Multiple Output) systems, and adaptive modulation and coding, among other things.

By leveraging the CSI readily available from existing Wi-Fi devices, innovative methodologies and algorithms to detect and classify objects have been developed. The hardware setups utilized may include Wi-Fi devices, such as laptops equipped with Wi-Fi transceivers, purpose-built computers, access points, CSI collectors, and other hardware used to transmit, receive, and/or measure Wi-Fi signals. The software setups employ various tools and frameworks, including CSI extraction and analysis tools to facilitate the collection and analysis of CSI data.

Two-branch encoder-decoder networks may be used for domain translation and Artificial Intelligence techniques, such as a k-nearest neighbors algorithm (KNN), may be used for feature selection and/or material classification.

In embodiments, the present platform may evaluate or otherwise measure progress in construction at a site by training an Artificial Intelligence (AI) system to detect subtle changes in Wi-Fi signal data between a transmitter and a receiver. The nodes may be placed in a virtual site to simulate how the Wi-Fi signal data will change during the construction project (e.g., as building elements are installed). Thereafter, the nodes may be positioned within the actual site, and the location of each node may be set.

When the nodes are in position, one or more (e.g., each) of the nodes may emit a Wi-Fi signal, and one or more (e.g., each) of the nodes may receive a Wi-Fi signal. Each node that receives a Wi-Fi signal may cause the received Wi-Fi signal to be processed. The processing may determine a difference between the emitted Wi-Fi signal and the received Wi-Fi signal. Based at least in part on the difference, the platform may determine one or more building elements have been installed. In embodiments the platform may create, based at least in part on the received Wi-Fi signal, a report indicating the current state of the site (e.g., showing building elements installed as part of the construction project). In some embodiments, the report may comprise an image generated based on the received Wi-Fi signal.

In some embodiments, the system may compare the determined construction update to a “ground truth.” The ground truth may include, as non-limiting examples, a 3d model of the completed job site, a construction blueprint, a construction schedule, and/or any other information regarding planned construction at the jobsite. In some embodiments, the comparison may be used to confirm the determination made by the system. For example, where the system determines that a metal duct was installed and the ground truth indicates that the finished jobsite should include the metal duct in that position, it can be inferred that the system correctly determined the construction progress. Additionally or alternatively, the comparison may be used to more accurately determine the position of the installed component.

Responsive to a determination that the determined component matches the ground truth (e.g., in location and component type), the system may determine that the component has been successfully installed, and may indicate the component as completed in a construction report. Responsive to a determination that there is a mismatch between the determined component and the ground truth (e.g., in terms of material and/or location of the component), the system may alert the user to a potential deviation from the construction plan. The system may prompt the user to visit the site to determine if an error has been made in the construction.

Embodiments of the present disclosure may comprise methods, systems, and a computer readable medium comprising, but not limited to, at least one of the following:
A. A Wi-Fi Emitter Module
B. A Wi-Fi Receiver Module
C. A Wi-Fi Measurement Module
D. A Communication Module
E. An Artificial Intelligence Module

In some embodiments, the present disclosure may provide an additional set of modules for further facilitating the software and hardware platform. The additional set of modules may comprise, but not be limited to:
F. A Camera Module

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components as found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
Position one or more trained nodes at a site;
Emit, from at least one node, a wireless signal;
Receive at least one node, a wireless signal;
Calculate an interference based on the emitted signal and the received signal; and
Determine, based on the calculated interference, one or more portions of a construction project at the site that have been completed;

Although the aforementioned method has been described to be performed by the intelligent site evaluation platform 100, it should be understood that a computing device 400 may be used to perform the various stages of the method. Furthermore, in some embodiments, different operations may be performed by different networked elements in operative communication with computing device 400. For example, a plurality of computing devices may be employed in the performance of some or all of the stages in the aforementioned method. Moreover, a plurality of computing devices may be configured much like a single computing device 400. Similarly, an apparatus may be employed in the performance of some or all stages in the method. The apparatus may also be configured much like computing device 400.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

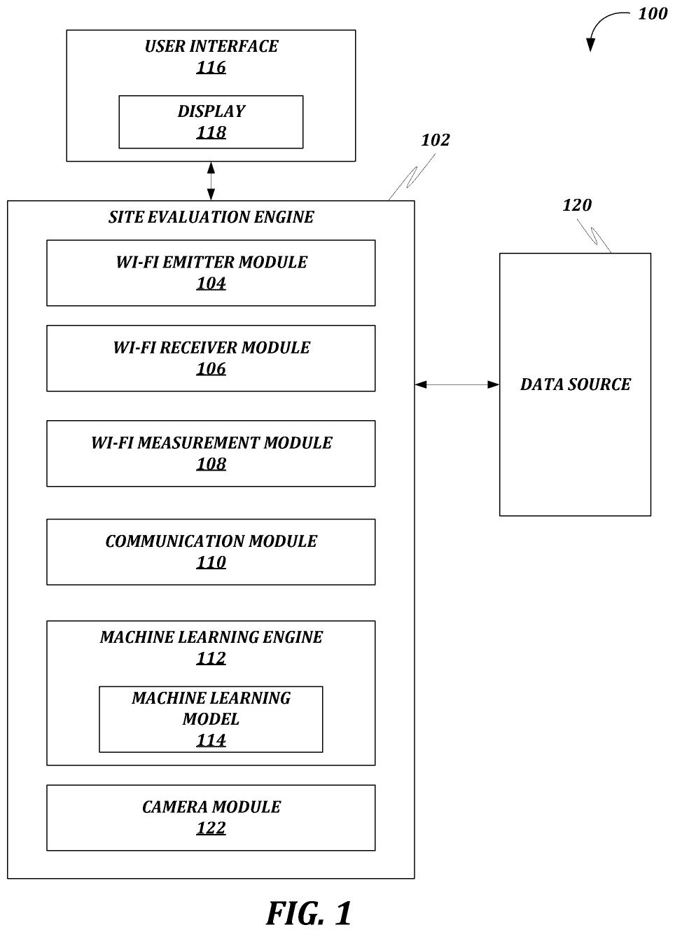

FIG. 1 illustrates one possible operating environment through which a platform consistent with embodiments of the present disclosure may be provided. By way of non-limiting example, an intelligent site evaluation platform 100 may be hosted on, for example, a cloud computing service. In some embodiments, the platform 100 may be hosted on a computing device 400. A user may access platform 100 through a software application and/or hardware device. The software application may be embodied as, for example, but not be limited to, a website, a web application, a desktop application, and a mobile application compatible with the computing device 400.

In embodiments, the platform 100 may include site evaluation engine 102. a user interface 116, a data source 120, and various components thereof. In one or more embodiments, the platform 100 may include more or fewer components than the components illustrated in FIG. 1. The components illustrated in FIG. 1 may be local to or remote from each other.

In one or more embodiments, the user interface 116 refers to hardware and/or software configured to facilitate communications between a user and the entity classification and data risk assessment engine 102. The user interface 116 may be used by a user who accesses an interface (e.g., a dashboard interface) for work and/or personal activities. The user interface 116 may be associated with one or more devices for presenting visual media, such as a display 118, including a monitor, a television, a projector, and/or the like. User interface 116 renders user interface elements and receives input via user interface elements. Examples of interfaces include (but need not be limited to) a graphical user interface (GUI), a command line interface (CLI), a haptic interface, and a voice command interface. Examples of user interface elements include (but need not be limited to) checkboxes, radio buttons, menus, dropdown lists, list boxes, buttons, toggles, text fields, date and time selectors, command lines, sliders, pages, and forms.

Accordingly, embodiments of the present disclosure provide a software and hardware platform comprised of a distributed set of computing elements, including, but not limited to:

### A. A Wi-Fi Emitter Module

The platform 100 may include one or more Wi-Fi emitter modules 104. Each Wi-Fi emitter module 104 may include hardware and/or software configured to emit Wi-Fi signals at the jobsite. The Wi-Fi emitter module may comprise a Wi-Fi transmitter. The Wi-Fi transmitter may be capable of transmitting Wi-Fi signals at standard Wi-Fi frequencies. In embodiments, the emitted Wi-Fi signals may include any signal compatible with a family of wireless network protocols based on the IEEE 802.11 family of standards, including, but not limited to, 802.11n, 802.11ac, and/or 802.11ax, which are commonly used for local area networking of devices and Internet access.

In some embodiments, the platform 100 may include a plurality of Wi-Fi emitter modules 104. The plurality of Wi-Fi emitter modules 104 may be disposed at different locations within the space to be analyzed.

In some embodiments, one or more (e.g., each) Wi-Fi emitter module 104 may include a battery pack. The battery pack may provide power to at least the Wi-Fi transmitter. In some embodiments, the battery pack may allow the Wi-Fi emitter module 104 to operate without being connected to an external power source.

A central processing unit (CPU) may be included in the Wi-Fi emitter module 104. The CPU may control the operation of the Wi-Fi transmitter. The CPU may be configured to perform edge computing tasks related to the Wi-Fi signal transmission.

In some embodiments, the Wi-Fi emitter module 104 may incorporate a cellular data connection, such as (but not limited to) a long-term evolution (LTE) connection, a 5G connection, and/or the like. The cellular data connection may enable the Wi-Fi emitter module 104 to communicate with remote systems. Data collected by the Wi-Fi emitter module 104 may be transmitted to one or more external devices and/or a cloud-based platform via the cellular data connection.

The Wi-Fi emitter module 104 may be housed in a rugged enclosure. The enclosure may protect components of the Wi-Fi emitter module 104 from environmental factors at the jobsite. In embodiments, the enclosure may be designed to withstand exposure to dust, moisture, physical impacts, temperature variation, and/or the like.

In some embodiments, a mounting mechanism may be included on the Wi-Fi emitter module 104. The mounting mechanism may allow the module to be securely attached to structures or objects at the jobsite. The mounting mechanism may be adjustable to enable selective positioning of the Wi-Fi transmitter.

The Wi-Fi emitter module 104 may include one or more antennas. In embodiment that include a plurality of antennas, the plurality of antennas may enable beamforming capabilities. Beamforming may allow the Wi-Fi signals produced by the Wi-Fi emitter module 104 to be directed more precisely within the jobsite environment.

### B. A Wi-Fi Receiver Module

The platform 100 may include one or more Wi-Fi receiver modules 106. A Wi-Fi receiver module 106 may refer to hardware and/or software configured to perform operations described herein (including such operations as may be incorporated by reference) for receiving a Wi-Fi signal. For example, the received signal may include the Wi-Fi signal from the Wi-Fi emitter module 104. In some embodiments, as shown in FIG. 1, the receiver module 106 and the emitter module 104 may be collocated within a single device. In other embodiments, the receiver module 106 may be embodied as a separate device from the emitter module 104.

In some embodiments, the platform 100 may include a plurality of Wi-Fi receiver modules 106. The plurality of Wi-Fi receiver modules 106 may be disposed at different locations within the space to be analyzed.

Each Wi-Fi receiver module 106 may include a Wi-Fi antenna configured to receive Wi-Fi signals. The Wi-Fi antenna may be connected to a Wi-Fi receiver chip. The Wi-Fi receiver chip may be capable of processing received Wi-Fi signals to extract channel state information (CSI) data.

The Wi-Fi receiver module 106 may include a central processing unit (CPU). The CPU may be configured to perform edge computing tasks on the extracted CSI data. The edge computing tasks may involve preprocessing of the CSI data (e.g., before transmission to other components).

In some embodiments, the Wi-Fi receiver module 106 may include a battery pack. The battery pack may allow for portable operation of the Wi-Fi receiver module 106 without requiring a constant external power source. In some embodiments (e.g., where the Wi-Fi emitter module 104 and the Wi-Fi receiver module 106 are collocated in a single device), a single battery pack may be used to provide power to both the Wi-Fi emitter module 104 and the Wi-Fi receiver module 106.

In some embodiments, the Wi-Fi receiver module 106 may incorporate a cellular data connection, such as (but not limited to) a long-term evolution (LTE) connection, a 5G connection, and/or the like. The cellular data connection may enable transmission of pre-processed CSI data to remote systems for further analysis.

A memory unit may be included in the Wi-Fi receiver module 106. The memory unit may store, among other things, extracted CSI data before pre-processing or transmission. The memory unit may also store software instructions for operating the Wi-Fi receiver module 106.

The Wi-Fi receiver module 106 may include an analog-to-digital converter (ADC). The ADC may convert received analog Wi-Fi signals into digital data for pre-processing by the CPU.

A digital signal processor (DSP) may be incorporated in the Wi-Fi receiver module 106. The DSP may perform specialized signal processing tasks on the digitized Wi-Fi signals. These tasks may include (but need not be limited to) noise reduction, signal enhancement, and/or the like.

In some embodiments, the Wi-Fi receiver module 106 may have multiple antennas to support multiple-input multiple-output (MIMO) operation. MIMO operation may allow for improved signal reception and data extraction in complex environments.

The Wi-Fi receiver module 106 may incorporate a real-time clock. The real-time clock may provide accurate timestamps for received Wi-Fi signals and extracted CSI data. Accurate timing information may be useful for synchronizing data from multiple receiver modules 106 and/or for establishing a timeline for changes at the jobsite.

The Wi-Fi receiver module 106 may have a rugged enclosure. The rugged enclosure may protect the internal components from dust, moisture, physical impacts, temperature variation, and/or the like. This protection may allow for deployment of the Wi-Fi receiver module 106 in harsh construction site environments. In some embodiments, (e.g., where the Wi-Fi emitter module 104 and the Wi-Fi receiver module 106 are collocated in a single device), a single enclosure may be used to protect both the Wi-Fi emitter module 104 and the Wi-Fi receiver module 106.

### C. A Wi-Fi Measurement Module

In embodiments the measurement of the Wi-Fi signal may include collection, identification, determination, and/or measurement of CSI data. CSI data may include known channel properties of a communication link. This information describes how a signal propagates from the transmitter to the receiver and represents the combined effect of, for example, scattering, fading, and power decay with distance. In this way, the CSI data may change when new objects are introduced between the transmitter and the receiver.

The platform 100 may include a Wi-Fi measurement module 108. The Wi-Fi measurement module 108 may refer to hardware and/or software configured to perform operations described herein (including such operations as may be incorporated by reference) for performing measurements based on Wi-Fi signals.

The Wi-Fi measurement module 108 may be configured to receive Wi-Fi signal data. For example, the Wi-Fi signal data may include Wi-Fi signals received directly at the Wi-Fi measurement module. Additionally or alternatively, the Wi-Fi signal data may include CSI data transmitted from the Wi-Fi receiver module 106. In some embodiments, the CSI data from the Wi-Fi emitter module may be pre-processed CSI data. The Wi-Fi measurement module 108 may perform one or more measurements based on the received Wi-Fi signal data.

The measurements performed by the Wi-Fi measurement module 108 may include (but need not be limited to) analyzing channel state information (CSI) data extracted from the received Wi-Fi signal data. The CSI data may provide information about the propagation of a Wi-Fi signal through the environment at the jobsite.

The Wi-Fi measurement module 108 may process the extracted CSI data to generate processed CSI data. This processing may include performing noise removal on the extracted CSI data. The processing may also include reconstructing complex CSI data from the noise-removed CSI data.

In some embodiments, the Wi-Fi measurement module may process the extracted CSI data locally, at the module. Additionally or alternatively, the Wi-Fi measurement module 108 may transmit data to a remote device and/or cloud-based platform for processing. The data may be used for analysis and/or visualization of construction progress at the jobsite. The remote device and/or cloud-based platform may provide a centralized location for storing and processing the Wi-Fi measurement data from multiple devices across one or more jobsites.

The Wi-Fi measurement module 108 may be configured to evaluate environmental effects on the measurements. This may include (but need not be limited to) analyzing how human activity or other dynamic factors in the environment impact the Wi-Fi signals and resulting CSI data. The module may implement techniques to mitigate these environmental effects and improve measurement accuracy.

The Wi-Fi measurement module 108 may be capable of discriminating objects at variable distances between transmitter and receiver nodes. This may allow for detection and classification of objects or structures regardless of their position relative to the nodes. The module 108 may use techniques to compensate for signal attenuation over longer distances.

The Wi-Fi measurement module 108 may be capable of discrimination of objects at variable locations within the measurement area. This may involve developing or determining one or more algorithms to accurately detect and classify objects regardless of where they are positioned between or around the transmitter and/or receiver nodes. The module 108 may use spatial analysis techniques to determine object locations.

In some embodiments, the Wi-Fi measurement module 108 may provide the processed CSI data as input into a trained machine learning model 114. As discussed below, the machine learning model 114 may be configured to analyze patterns in the CSI data that correspond to the presence of physical objects or structures at the jobsite.

In some embodiments, the Wi-Fi measurement module 108 may receive an output from the trained machine learning model 114. The output may include an indication of construction progress at the jobsite. This indication may take various forms, such as (but not limited to) a rendering of the jobsite, a textual description of the jobsite, and/or a status indicator of one or more objects disposed within the jobsite.

### D. A Communication Module

A communication module 110 may refer to hardware and/or software configured to perform operations described herein (including such operations as may be incorporated by reference) for transmitting communications to and/or receiving communications from one or more other devices (e.g., transmissions among the Wi-Fi emitter module 104, the Wi-Fi receiver module 106, the Wi-Fi measurement module 108, the artificial intelligence module 114, one or more remote devices, one or more cloud-based platforms, etc.).

In embodiments, the communication module 110 may use wireless communication technologies including (but not limited to) one or more of Wi-Fi communications, Bluetooth (IEEE 802.15) communications, cellular (e.g., edge, GPRS, 3G, LTE, 5G, etc.) communications, Radio Frequency communications, and/or the like. Additionally or alternatively, the communication module 110 may use wired (e.g., IEEE 802.3) communication methods to transmit the data.

### E. An Artificial Intelligence Model

In an embodiment, one or more components of the site evaluation engine 102 may use an artificial intelligence, such as a machine learning engine 112. In particular, the machine learning engine 112 may be used to determine changes to a job site based on changes to a received Wi-Fi signal (e.g., based on measurements from the measurement module 108). Machine learning includes various techniques in the field of artificial intelligence that deal with computer-implemented, user-independent processes for solving problems that have variable inputs.

In some embodiments, the machine learning engine 112 trains a machine learning model 114 to perform one or more operations. Training a machine learning model 114 uses training data to generate a function that, given one or more inputs to the machine learning model 114, computes a corresponding output. The output may correspond to a prediction based on prior machine learning. In an embodiment, the output includes a label, classification, and/or categorization assigned to the provided input(s). The machine learning model 114 corresponds to a learned model for performing the desired operation(s) (e.g., labeling, classifying, and/or categorizing inputs). The site evaluation engine 102 may use multiple machine learning engines 112 and/or multiple machine learning models 114 for different purposes.

In embodiments, the machine learning engine 112 may use supervised learning, semi-supervised learning, unsupervised learning, reinforcement learning, and/or any other training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 112 receives positive and/or negative reinforcement in the process of attempting to solve a particular problem (e.g., to optimize performance in a particular scenario, according to one or more predefined performance criteria). One example of a network for use in reinforcement learning is a recurrent neural network, which may include a backpropagation or feedback pathway to correct or improve the response of the network.

In an embodiment, a machine learning engine 112 may use many different techniques to label, classify, and/or categorize inputs. A machine learning engine 112 may transform inputs (e.g., the measured Wi-Fi signals) into feature vectors that describe one or more properties (“features”) of the inputs. The machine learning engine 112 may label, classify, and/or categorize the inputs based on the feature vectors. Alternatively or additionally, a machine learning engine 112 may use clustering (also referred to as cluster analysis) to identify commonalities in the inputs. The machine learning engine 112 may group (i.e., cluster) the inputs based on those commonalities. The machine learning engine 112 may use hierarchical clustering, k-means clustering, and/or another clustering method or combination thereof. For example, the machine learning engine 112 may receive, as inputs, one or more wireless signal measurements comprising a change in the wireless signal over a period of time, and may determine a particular set of construction supplies that would result in the change (e.g., based on measured changes from previous sites, expected construction work at the present site, etc.).

In an embodiment, a machine learning engine 112 includes an artificial neural network such as a feed forward neural network. An artificial neural network includes multiple nodes (also referred to as artificial neurons) and edges between nodes. Edges may be associated with corresponding weights that represent the strengths of connections between nodes, which the machine learning engine 112 adjusts as machine learning proceeds. As a particular example, the neural network may be a feed-forward neural network (FFNN). Alternatively or additionally, a machine learning engine 112 may include a support vector machine. A support vector machine represents inputs as vectors. The machine learning engine 112 may label, classify, and/or categorize inputs based on the vectors. Alternatively or additionally, the machine learning engine 112 may use a naïve Bayes classifier to label, classify, and/or categorize inputs. Alternatively or additionally, given a particular input, a machine learning model may apply a decision tree to predict an output for the given input. Alternatively or additionally, a machine learning engine 112 may apply fuzzy logic in situations where labeling, classifying, and/or categorizing an input among a fixed set of mutually exclusive options is impossible or impractical. The aforementioned machine learning model 114 and techniques are discussed for exemplary purposes only and should not be construed as limiting one or more embodiments.

In embodiments, the machine learning model may be trained by, for example, creating a data set. As a particular example, for a data set used for training the machine learning model to identify building materials, the data set may include a plurality of baseline samples having no object between the transmitter and the receiver, a plurality of samples having a metal pipe between the receiver, a plurality of sample having a 1.5 inch polyvinyl chloride (PVC) pipe or conduit between the transmitter and the receiver, a plurality of samples having a 0.5 inch PVC conduit between the transmitter and the receiver, and a plurality of samples having a metal air duct between the transmitter and the receiver. The data set may be split into a training set and a testing set as is known in the art. For example, 80% of the collected data set may be used to form the training set, and the remaining 20% of the data set may be used as the testing set.

In an embodiment, as a machine learning engine 112 applies different inputs to a machine learning model 114, the corresponding outputs are not always accurate. As an example, the machine learning engine 112 may use supervised learning to train a machine learning model 114. After training the machine learning model 114, if a subsequent input is identical to an input that was included in labeled training data and the output is identical to the supervisory signal in the training data, then output is certain to be accurate. If an input is different from inputs that were included in labeled training data, then the machine learning engine 112 may generate a corresponding output that is inaccurate or of uncertain accuracy. In addition to producing a particular output for a given input, the machine learning engine 112 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

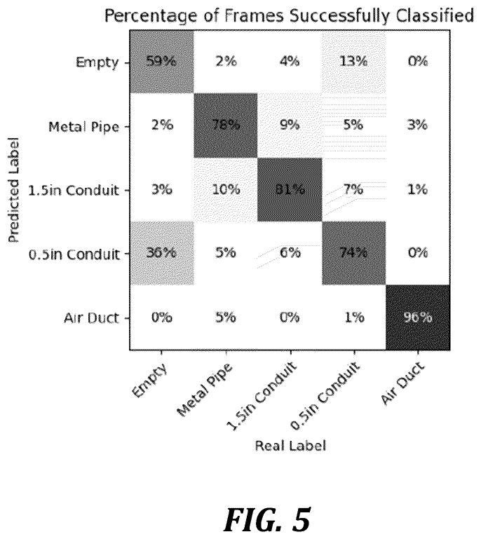

As shown in FIG. 5, the machine learning model 114 correctly classified areas in most cases. In particular, for regions containing an air duct, the label was successfully applied 96% of the time; for regions containing a 0.5 inch PVC conduit, the label was successfully applied 74% of the time; for areas containing a 1.5 inch conduit, the label was correctly applied 81% of the time, and for regions containing a metal pipe the label was correctly applied 78% of the time. For regions or areas that were empty, the label was correctly applied 59% of the time. These results demonstrate the ability of the model to distinguish between objects based on the measured Wi-Fi data.

In an embodiment, the site evaluation engine 102 is configured to receive data from one or more data sources 120. A data source 120 refers to hardware and/or software used to store data relevant to the processing performed by the engine 102. For example, the data source may store a construction schedule for a jobsite, a list of materials approved for use at the jobsite, and/or any other information that may be useful for the site evaluation engine 102. In some embodiments, the data source 120 may be external, operating independent of the entity classification and data risk assessment engine 102. For example, the hardware and/or software of the external data source 120 may be under control of a different entity (e.g., a different company or other kind of organization) than an entity that controls the entity classification and data risk assessment engine.

In an embodiment, the site evaluation engine 102 is configured to retrieve data from a data source 120 by ‘pulling’ the data via an application programming interface (API) of the external data source 120, using user credentials that a user has provided for that particular data source 120. Alternatively or additionally, a data source 120 may be configured to ‘push’ data to the site evaluation engine 102 via an API, using an access key, password, and/or other kind of credential that a user has supplied to the external data source 120. The entity classification and data risk assessment engine 102 may be configured to receive data from an external data source 120 in many different ways.

As one example, the site evaluation engine may retrieve a ground truth file comprising one or more of a 3d model of the completed job site, a construction blueprint for the job site, a construction plan for the job site, and/or any other document that includes a listing of planned components to be installed at the job site. In embodiments, the site evaluation engine 102 may be configured to compare one or more components that are determined to have been installed (e.g., by the machine learning engine 112) to a retrieved ground truth document. In some embodiments, responsive to a determination that the determined component matches the ground truth (e.g., in location and component type), the site evaluation engine 102 may determine that the component has been successfully installed, and may indicate the component as completed in a construction report. Responsive to a determination that there is a mismatch between the determined component and the ground truth (e.g., in terms of material and/or location of the component), the site evaluation engine 102 may alert the user to a potential deviation from the construction plan. The site evaluation engine 102 may prompt the user to visit the site to determine if an error has been made in the construction.

### F. A Camera Module

In some embodiments, the platform 100 may include a camera module 122. A camera module 122 may refer to hardware and/or software configured to perform operations described herein (including such operations as may be incorporated by reference) for capturing digital images of an area using visible spectrum and/or near-visible spectrum (e.g., infrared, ultraviolet) radiation. For example, camera module 122 may be used in combination with the Wi-Fi measurement module 108 to collect data for use with the machine learning engine 112.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

The method may comprise positioning one or more Wi-Fi nodes at a construction site. Each Wi-Fi node may include a Wi-Fi transmitter and/or a Wi-Fi receiver. The Wi-Fi nodes may be configured to emit and/or receive Wi-Fi signals. Wi-Fi signals may be emitted from at least one of the one or more Wi-Fi nodes. The Wi-Fi signals may be emitted at a predetermined frequency and bandwidth. The emitted Wi-Fi signals may be received by at least one of the one or more Wi-Fi nodes. The receiving node may be configured to collect at least channel state information (CSI) data from the received Wi-Fi signals.

CSI data is extracted from the received Wi-Fi signals. The CSI data may contain information about the amplitude and phase of the Wi-Fi signals as they propagate through the construction site environment. The extracted CSI data is processed. The processing may include noise removal techniques to mitigate environmental interference, principal component analysis (PCA) to reduce dimensionality, feature extraction, and/or the like. The processing may also include reconstructing complex CSI data from the noise-removed CSI data.

The processed CSI data may be input into a trained machine learning model. The machine learning model may be trained using a dataset comprising CSI data collected under various construction site conditions and corresponding ground truth data indicating actual construction progress. The trained machine learning model may generate an output indicating construction progress at the construction site. The output may comprise information about the presence, absence, and/or status of specific construction materials or components at the site. In embodiments, the output may comprise location information related to each detected object.

The method may optionally comprise generating a visual representation of the construction progress based on the output of the trained machine learning model. As non-limiting examples, the visual representation may include a 2D or 3D rendering of the construction site showing completed and in-progress areas.

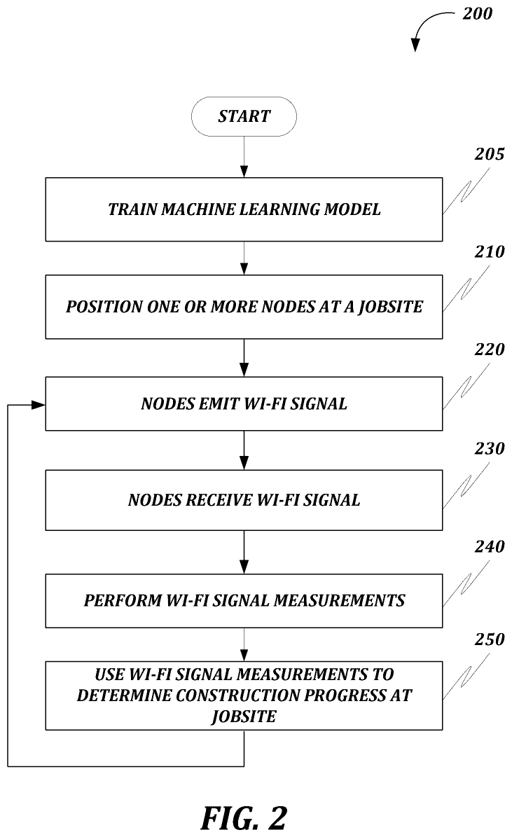

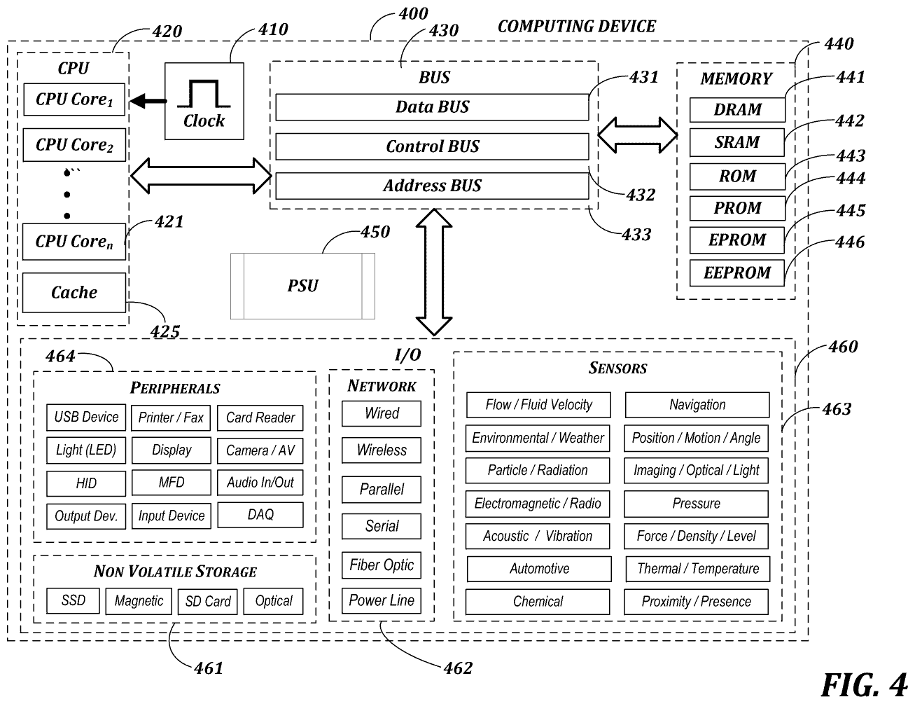

FIG. 2 is a flow chart setting forth the general stages involved in a method 200 consistent with an embodiment of the disclosure for providing the intelligent site evaluation platform 100. Method 200 may be implemented using a computing device 400 or any other component associated with platform 100 as described in more detail below with respect to FIG. 4. For illustrative purposes alone, computing device 400 is described as one potential actor in the following stages.

Method 200 may begin at stage 205, where a computing device may train the machine learning model. In some embodiments, the machine learning model is trained using a training dataset that includes CSI data collected under various construction site conditions and corresponding ground truth data indicating actual construction progress. In some embodiments, training the machine learning model may include setting a “virtual position” for one or more nodes (e.g., one or more Wi-Fi emitter modules, Wi-Fi receiver modules, and/or Wi-Fi measurement modules) in a virtual environment prior to deploying the one or more nodes at the jobsite, and setting a location for each of the one or more nodes in the virtual environment. The virtual environment may be designed to mirror a jobsite at which the nodes are to be deployed, or may be a generic virtual jobsite. Once the one or more nodes are positioned in the virtual environment, various stages of construction can be simulated within the virtual environment. In at least some embodiments, the simulated construction in the virtual; environment may mirror the planned construction at the jobsite.

The computing device may simulate emission of a Wi-Fi signal from at least one of the one or more nodes and reception of the emitted Wi-Fi signal by at least one of the one or more nodes. In this way, the receiving node may receive and measure at least simulated CSI data. In some embodiments, the machine learning model may be trained to identify building materials based on one or more simulated measurements related to the simulated received Wi-Fi signal and the simulated stages of construction, and proceed to stage.

In stage 210, one or more nodes may be positioned at a jobsite. The nodes may be positioned in substantially the same position as in the simulated jobsite. In embodiments, each node may include a Wi-Fi transmitter module, a Wi-Fi receiver module, and/or a Wi-Fi measurement module. One or more (e.g., each) of the nodes that includes a Wi-Fi measurement module may be configured to determine materials disposed within the jobsite independently. Additionally or alternatively, one or more (e.g., each) of the nodes that includes a Wi-Fi measurement module may be configured to transmit the Wi-Fi measurement data (e.g., including CSI data) to a separate device that may compile received Wi-Fi measurement data to determine materials disposed within the jobsite.

For example, the one or more nodes may include one or more trained nodes. In some embodiments, one or more (e.g., each) of the one or more nodes may have been trained within a virtual site that is expected to mirror the conditions of the actual jobsite. The virtual site may be used to simulate the expected changes to the Wi-fi signal emitted from the nodes and/or collected at the nodes as the construction progresses.

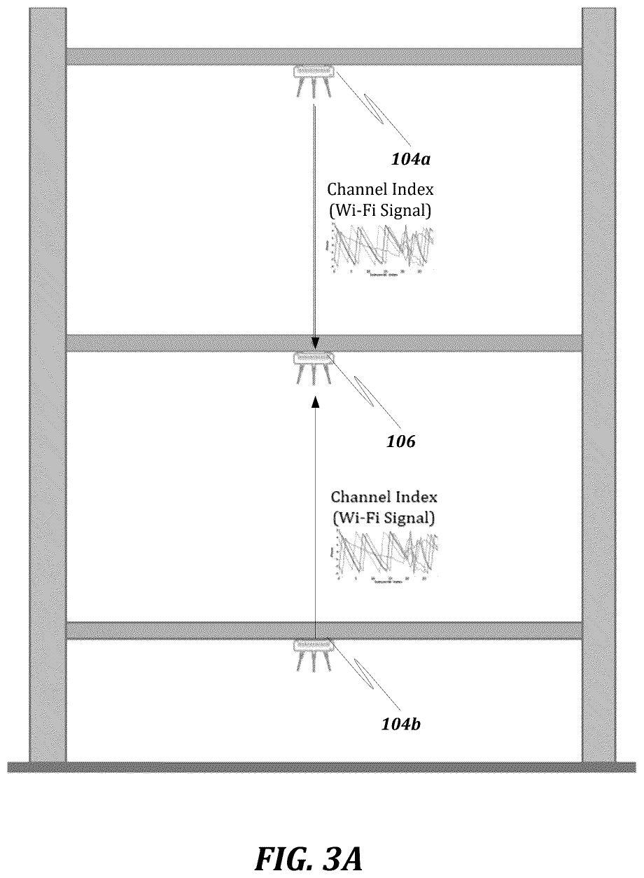

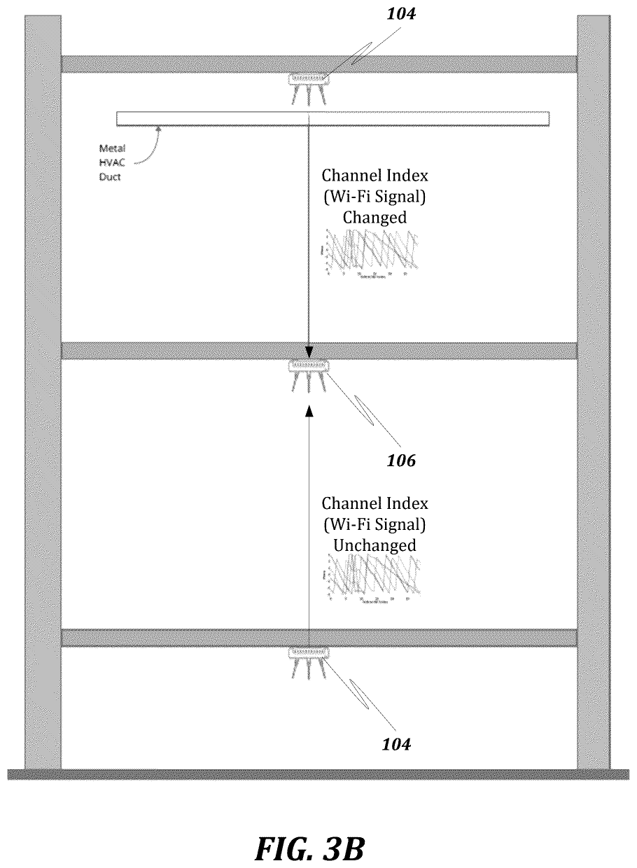

In some embodiments, each node is associated with a particular position at the jobsite. For example, as shown in FIG. 3A, three nodes are each positioned at three distinct locations within the jobsite. One of skill in the art will appreciate, however, that more or fewer nodes may be used, and that different node configurations are possible, without departing from the scope of the invention. As shown in FIG. 3A, a first node comprising a Wi-Fi emitter 104a emits a first Wi-Fi signal, and a second node comprising a Wi-Fi receiver 106 receives the first signal emitted from the first node and extracts CSI data. The CSI data from the first received signal is analyzed to determine that no objects are positioned between the first node and the second node. Similarly, a third node comprising a Wi-Fi emitter 104b emits a second Wi-Fi signal, and the second node receives the second signal emitted from the third node and extracts CSI data. The CSI data from the second signal is analyzed to determine that no objects are positioned between the third node and the second node.

From stage 210, where the nodes are positioned at the jobsite, method 200 may advance to stage 220 where computing device 400 may cause at least one of the one or more nodes to emit a Wi-Fi signal. For example, the Wi-Fi signal may include any signal that is compliant with one or more of the IEEE 802.11 family of specifications. In embodiments, transmitting the Wi-Fi signal may comprise transmitting a plurality of separate signals (e.g., channels) having different frequencies. For example, the signals may be located in the 2.4 GHz, 5 GHz and/or 6 GHz frequency range, and may be separated by 5 MHz.

In stage 230, computing device 400 may receive an emitted Wi-Fi signal (e.g., the signal emitted in stage 220). In embodiments, receiving the signal may include receiving the plurality of channel signals emitted in stage 220. <third stage from method claim 1>. In some embodiments, receiving the Wi-Fi signal may include constructing a Wi-Fi Channel Index for the Wi-Fi signal, showing the signal strength of each of the received channel signals.

After computing device 400 receives the Wi-Fi signal in stage 230, method 200 may proceed to stage 240 where computing device 400 may perform a measurement based on the Wi-Fi signal. For example, the Wi-Fi signal may be measured to determine a level of interference at each channel of the signal.

In embodiments, measuring the Wi-Fi signal may include measuring one or more aspects of each channel of the signal. For example, the computing device may measure a signal strength (e.g., in decibels) of each channel of the received Wi-Fi signal. In some embodiments, measuring the Wi-Fi signal may comprise determining a difference between the signal as it was emitted and the signal as it was received. Additionally or alternatively, measuring the Wi-Fi signal may include determining a change in the Wi-Fi signal over time. For example, measuring the Wi-Fi signal may include determining a change in one or more properties of the Wi-Fi signal from a previous time (t−1) (e.g., as shown in FIG. 3A, when no construction has been completed) to the current time (t) (e.g., as shown in FIG. 3B, where a metal HVAC duct has been installed near one of the nodes). As shown in FIG. 3B, the first node comprising a Wi-Fi emitter 104a emits a first Wi-Fi signal, and the second node comprising a Wi-Fi receiver 106 receives the first signal emitted from the first node and extracts CSI data. The CSI data (and/or changes to the CSI data from time from (t−1) to time (t)) indicate that an object is interposed between the first node and the second node. The CSI data may be analyzed (e.g., by a trained machine learning model) to determine the location of the interposed object (e.g., a distance and/or direction from the first node and/or the second node) and/or one or more object characteristics (e.g., identifying the object as a metal duct). In contrast, the third node comprising a Wi-Fi emitter 104b emits a second Wi-Fi signal, and the second node receives the second signal emitted from the third node and extracts CSI data. The CSI data from the second signal (and/or the differences between the CSI data from time from (t−1) to time (t)) is analyzed to determine that no substantial changes have been occurred in the CSI data and that no objects are positioned between the third node and the second node.

In some embodiments, at least one of the measurements may be performed at the node that received the signal. Additionally or alternatively, the node may transmit the received signal to a separate device configured to perform at least one of the measurements of the signal.

In stage 250, the computing device may provide the measurements to a trained machine learning engine for use in determining a stage of construction at the jobsite. For example, the machine learning engine may receive, as inputs, a vector comprising the Wi-Fi signal measurements. In some embodiments, the machine learning engine may receive additional information, such as (but not limited to) information associated with the jobsite, information indicating a location of the node that received the Wi-Fi signal, information about the expected construction schedule at the job site, and/or any other information concerning the jobsite, the node, and/or the measured signal. The machine learning engine may provide, as output, a report indicating construction progress at the jobsite. The report may include, as non-limiting examples, a textual description of work that has been completed, a visual representation (e.g., a photograph, rendering, etc.) of work that has been completed, or any other indication of work that has been completed. In embodiment, the report may be generated based on a threshold difference in measurements between the previous time and the current time. Alternatively, the report may be updated each time a new measurement is received.

In some embodiments, creating and/or updating the report may include comparing one or more components that are determined to have been installed to a retrieved ground truth document. In some embodiments, responsive to a determination that the determined component matches the ground truth (e.g., in location and component type), the report may indicate that the component has been successfully installed. Responsive to a determination that there is a mismatch between the determined component and the ground truth (e.g., in terms of material and/or location of the component), the report may include an alert indicating to the user that a potential deviation from the construction plan has been detected. The report may prompt the user to visit the site to determine if an error has been made in the construction.

Once computing device 400 outputs the report in stage 240, method 200 may return to stage 220, where the signal may be emitted. In embodiments, the signal may be emitted intermittently, periodically, or substantially continuously. In some embodiments, the measurements may be performed in real-time or substantially in real time.

### IV. Hardware Configuration

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 400. The computing device 400 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
Platform 100 may be hosted on a centralized server or a cloud computing service. Although method 200 has been described to be performed by a computing device 400, it should be understood that, in some embodiments, different operations may be performed by a plurality of the computing devices 400 in operative communication on at least one network.

Embodiments of the present disclosure may comprise a system having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for redundancy, high availability, and/or performance purposes. The combination of the presently disclosed units is configured to perform the stages of any method disclosed herein.

FIG. 4 is a block diagram of a system including computing device 400. Consistent with an embodiment of the disclosure, the aforementioned CPU 420, the bus 430, the memory unit 440, a PSU 450, and the plurality of I/O units 460 may be implemented in a computing device, such as computing device 400 of FIG. 4. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, and the memory unit 440, consistent with embodiments of the disclosure.

At least one computing device 400 may be embodied as any of the computing elements illustrated in all of the attached figures. A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In some configurations, the computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

In a system consistent with an embodiment of the disclosure, the computing device 400 may include the clock module 410, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 420, the central component of modern computers, which relies on a clock signal. The clock 410 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 400 may use a “clock multiplier” which multiplies a lower frequency external clock to the appropriate clock rate of the CPU 420. This allows the CPU 420 to operate at a much higher frequency than the rest of the computing device 400, which affords performance gains in situations where the CPU 420 does not need to wait on an external factor (like memory 440 or input/output 460). Some embodiments of the clock 410 may include dynamic frequency change, where the time between clock edges can vary widely from one edge to the next and back again.

In a system consistent with an embodiment of the disclosure, the computing device 400 may include the CPU 420 comprising at least one CPU Core 421. In other embodiments, the CPU 420 may include a plurality of identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU 420 reads and executes program instructions which may be used across many application domains, for example, but not limited to, general purpose computing, embedded computing, network computing, digital signal processing (DSP), and graphics processing (GPU). The CPU 420 may run multiple instructions on separate CPU cores 421 simultaneously. The CPU 420 may be integrated into at least one of a single integrated circuit die, and multiple dies in a single chip package. The single integrated circuit die and/or the multiple dies in a single chip package may contain a plurality of other elements of the computing device 400, for example, but not limited to, the clock 410, the bus 430, the memory 440, and I/O 460.

The CPU 420 may contain cache 422 such as but not limited to a level 1 cache, a level 2 cache, a level 3 cache, or combinations thereof. The cache 422 may or may not be shared amongst a plurality of CPU cores 421. The cache 422 sharing may comprise at least one of message passing and inter-core communication methods used for the at least one CPU Core 421 to communicate with the cache 422. The inter-core communication methods may comprise, but not be limited to, bus, ring, two-dimensional mesh, and crossbar. The aforementioned CPU 420 may employ symmetric multiprocessing (SMP) design.

The one or more CPU cores 421 may comprise soft microprocessor cores on a single field programmable gate array (FPGA), such as semiconductor intellectual property cores (IP Core). The architectures of the one or more CPU cores 421 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the computing device 400, and/or the plurality of computing devices 400. The aforementioned communication system will be known to a person having ordinary skill in the art as a bus 430. The bus 430 may embody internal and/or external hardware and software components, for example, but not limited to a wire, an optical fiber, various communication protocols, and/or any physical arrangement that provides the same logical function as a parallel electrical bus. The bus 430 may comprise at least one of a parallel bus, wherein the parallel bus carries data words in parallel on multiple wires; and a serial bus, wherein the serial bus carries data in bit-wise serial form. The bus 430 may embody a plurality of topologies, for example, but not limited to, a multidrop/electrical parallel topology, a daisy chain topology, and connected by switched hubs, such as a USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard.
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 400 may employ hardware integrated circuits that store information for immediate use in the computing device 400, known to persons having ordinary skill in the art as primary storage or memory 440. The memory 440 operates at high speed, distinguishing it from the non-volatile storage sub-module 461, which may be referred to as secondary or tertiary storage, which provides relatively slower-access to information but offers higher storage capacity. The data contained in memory 440 may be transferred to secondary storage via techniques such as, but not limited to, virtual memory and swap. The memory 440 may be associated with addressable semiconductor memory, such as integrated circuits consisting of silicon-based transistors, that may be used as primary storage or for other purposes in the computing device 400. The memory 440 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 400 may employ a communication system between an information processing system, such as the computing device 400, and the outside world, for example, but not limited to, human, environment, and another computing device 400. The aforementioned communication system may be known to a person having ordinary skill in the art as an Input/Output (I/O) module 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces with a plurality of hardware, such as, but not limited to, non-volatile storage 461, communication devices 462, sensors 463, and peripherals 464. The plurality of hardware is used by at least one of, but not limited to, humans, the environment, and another computing device 400 to communicate with the present computing device 400. The I/O module 460 may comprise a plurality of forms, for example, but not limited to channel I/O, port mapped I/O, asynchronous I/O, and Direct Memory Access (DMA).

Consistent with the embodiments of the present disclosure, the aforementioned computing device 400 may employ a non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using an intermediate area in the memory 440. The non-volatile storage sub-module 461 may not lose data when power is removed and may be orders of magnitude less costly than storage used in memory 440. Further, the non-volatile storage sub-module 461 may have a slower speed and higher latency than in other areas of the computing device 400. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 400 may employ a communication sub-module 462 as a subset of the I/O module 460, which may be referred to by a person having ordinary skill in the art as at least one of, but not limited to, a computer network, a data network, and a network. The network may allow computing devices 400 to exchange data using connections, which may also be known to a person having ordinary skill in the art as data links, which may include data links between network nodes. The nodes may comprise networked computer devices 400 that may be configured to originate, route, and/or terminate data. The nodes may be identified by network addresses and may include a plurality of hosts consistent with the embodiments of a computing device 400. Examples of computing devices that may include a communication sub-module 462 include, but are not limited to, personal computers, phones, servers, drones, and networking devices such as, but not limited to, hubs, switches, routers, modems, and firewalls.

Two nodes can be considered networked together when one computing device 400 can exchange information with the other computing device 400, regardless of any direct connection between the two computing devices 400. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 462 may comprise a plurality of size, topology, traffic control mechanisms and organizational intent policies. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 400 may employ a sensors sub-module 463 as a subset of the I/O 460. The sensors sub-module 463 comprises at least one of the device, module, or subsystem whose purpose is to detect events or changes in its environment and send the information to the computing device 400. Sensors may be sensitive to the property they are configured to measure, may not be sensitive to any property not measured but be encountered in its application, and may not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ a peripherals sub-module 464 as a subset of the I/O 460. The peripheral sub-module 464 comprises ancillary devices used to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 400. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 400 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   O Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 462), data storage devices (non-volatile storage 461), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

1. A system for monitoring construction progress at a jobsite, the system comprising:
one or more nodes positioned at the jobsite;
at least one hardware processor; and
one or more computer-readable storage media storing instructions which, when executed by the at least one hardware processor, cause the system to perform operations comprising:
emitting a Wi-Fi signal from at least one of the one or more nodes,
receiving the emitted Wi-Fi signal by at least one of the one or more nodes,
performing one or more measurements based at least in part on the received Wi-Fi signal,
providing the one or more measurements as input to a trained machine learning model, and
generating, as output from the trained machine learning model, an indication of construction progress at the jobsite.

2. The system of claim 1, wherein the indication of construction progress comprises one or more of:
a rendering of the jobsite, or
a textual description of the jobsite.

3. The system of claim 1, wherein the machine learning model is trained by performing operations comprising:
virtually positioning the one or more nodes in a virtual environment prior to deploying the one or more nodes at the jobsite;
setting a location for each of the one or more nodes in the virtual environment;
simulating various stages of construction within the virtual environment, wherein the simulated construction mirrors the construction at the jobsite;
simulating emission of a Wi-Fi signal from at least one of the one or more nodes and reception of the emitted Wi-Fi signal by at least one of the one or more nodes; and
training the machine learning model to identify building materials based on one or more simulated measurements related to the simulated emission and reception of the Wi-Fi signal and the simulated stages of construction.

4. The system of claim 3, wherein the one or more nodes are positioned at the jobsite to correspond to the positions at which the nodes were virtually positioned in the virtual environment.

5. The system of claim 3, wherein training the machine learning model comprises:
training the machine learning model using a dataset comprising:
CSI data collected under various construction site conditions; and
corresponding ground truth data indicating actual construction progress.

6. The system of claim 1, wherein the operations further comprise:
sending data from the one or more nodes to a cloud-based platform for analysis and visualization of the construction progress.

7. The system of claim 1, wherein performing the one or more measurements comprises at least one of the following:
performing principal component analysis (PCA) on the CSI data to reduce dimensionality,
extracting features from the dimensionality-reduced CSI data,
analyzing channel state information (CSI) data extracted from the received Wi-Fi signal,
performing noise removal on the extracted CSI data, or
reconstructing complex CSI data from the noise-removed CSI data.

8. The system of claim 1, each node comprising a Wi-Fi transmitter, a Wi-Fi receiver, a battery pack, a central processing unit, and a cellular data connection.

9. A method for monitoring construction progress at a jobsite, comprising:
positioning one or more Wi-Fi nodes at a construction site;
emitting Wi-Fi signals from at least one of the one or more Wi-Fi nodes;
receiving, by at least one of the one or more Wi-Fi nodes, the emitted Wi-Fi signals;
extracting channel state information (CSI) data from the received Wi-Fi signals;
processing the extracted CSI data to generate processed CSI data;
inputting the processed CSI data into a trained machine learning model; and
generating, by the trained machine learning model, an output indicating construction progress at the construction site;
wherein the method is performed by at least one computing device comprising a hardware processor.

10. The method of claim 9, further comprising:
generating a description of the construction progress based on the output of the trained machine learning model, wherein the description comprises one or more of:
a rendering of the jobsite, or
a textual description of the jobsite.

11. The method of claim 9, wherein the machine learning model is trained by performing operations comprising:
virtually positioning the one or more nodes in a virtual environment prior to deploying the one or more nodes at the jobsite;
setting a location for each of the one or more nodes in the virtual environment;
simulating various stages of construction within the virtual environment, wherein the simulated construction mirrors the construction at the jobsite;
simulating emission of a Wi-Fi signal from at least one of the one or more nodes and reception of the emitted Wi-Fi signal by at least one of the one or more nodes; and
training the machine learning model to identify building materials based on one or more simulated measurements related to the simulated emission and reception of the Wi-Fi signal and the simulated stages of construction.

12. The method of claim 11, wherein the one or more nodes are positioned at the jobsite to correspond to the positions at which the nodes were virtually positioned in the virtual environment.

13. The method of claim 11, wherein training the machine learning model comprises:
training the machine learning model using a dataset comprising:
CSI data collected under various construction site conditions; and
corresponding ground truth data indicating actual construction progress.

14. The method of claim 9, further comprising:
sending data from the one or more nodes to a cloud-based platform for analysis and visualization of the construction progress.

15. The method of claim 9, wherein performing the one or more measurements comprises at least one of the following:
performing principal component analysis (PCA) on the CSI data to reduce dimensionality,
extracting features from the dimensionality-reduced CSI data,
analyzing channel state information (CSI) data extracted from the received Wi-Fi signal,
performing noise removal on the extracted CSI data, or
reconstructing complex CSI data from the noise-removed CSI data.

16. The method of claim 15, wherein processing the extracted CSI data comprises:
performing noise removal on the extracted CSI data; and
reconstructing complex CSI data from the noise-removed CSI data.

17. One or more non-transitory computer readable media comprising instructions which, when executed by one or more hardware processors, causes performance of operations comprising:
receiving, at a computing device, Channel State Information (CSI) data collected from one or more Wi-Fi nodes positioned at a construction site;
processing the CSI data to extract features indicative of physical objects present at the construction site;
providing the extracted features as input to a trained machine learning model;
generating, using the trained machine learning model, a representation of the construction site based on the extracted features;
comparing the generated representation to a predetermined construction plan for the construction site;
determining, based on the comparison, a measure of construction progress at the construction site; and
outputting an indication of the determined measure of construction progress.

18. The non-transitory computer readable media of claim 17, wherein the operations further comprise:
receiving image data of the construction site captured during a training phase;
synchronizing the received image data with corresponding CSI data collected during the training phase; and
training the machine learning model using the synchronized image data and CSI data to learn correlations between CSI data patterns and physical objects.

19. The non-transitory computer readable media of claim 17, wherein processing the CSI data comprises:
performing principal component analysis (PCA) on the CSI data to reduce dimensionality,
extracting features from the dimensionality-reduced CSI data,
analyzing channel state information (CSI) data extracted from the received Wi-Fi signal,
performing noise removal on the extracted CSI data, or
reconstructing complex CSI data from the noise-removed CSI data.

20. The non-transitory computer readable media of claim 17, wherein the operations further comprise:
detecting, based on the generated representation, presence or absence of specific construction materials at predetermined locations within the construction site; and
wherein determining the measure of construction progress comprises quantifying an amount of detected construction materials relative to the predetermined construction plan.
